(19) United States
(12) Patent Application Publication
(10) Pub. No.: US 2007/0224567 A1
(43) Pub. Date: Sep. 27, 2007

(54) Dental orthotic and methods of using the same

(76) Inventor: Farrand C. Robson, Tacoma, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/651,426

(22) Filed: Jan. 8, 2007

Related U.S. Application Data
(60) Provisional application No. 60/756,683, filed on Jan. 6, 2006.
(60) Provisional application No. 60/838,004, filed on Aug. 15, 2006.

(51) Int. Cl. A61C 3/00

(52) U.S. Cl. 433/6

(57) ABSTRACT

Apparatuses, systems, and methods for treating oral functions are shown and described. An orthotic dental system for treating oral functions includes an upper dentition orthotic, a lower dentition orthotic, and an articulator system. The articulator system extends between the upper and lower dentition orthotics and can have at least one rigid connector pivotally coupled to the upper dentition orthotic and the lower dentition orthotic. A spacer can be positioned and configured to spatially separate the upper dentition orthotic and the lower dentition orthotic a desired minimum distance. The orthotic dental system can improve various types of oral functions.

### CROSS-REFERENCES TO RELATED APPLICATIONS

This application claims the benefit under 35 U.S.C. § 119(e) of U.S. Provisional Patent Application No. 60/756,683 filed on Jan. 6, 2006 and U.S. Provisional Patent Application No. 60/838,004 filed on Aug. 15, 2006, where these two provisional applications are incorporated herein by reference in their entireties.

### BACKGROUND OF THE INVENTION

1. Field of the Invention

The present disclosure is generally related to orthotics. In particular, the present disclosure relates to wearable intraoral dental orthotics.

2. Description of the Related Art

Intraoral devices are often used to treat and relieve upper airway disorders that cause impairment of primary oral functions, such as swallowing, speaking, and breathing, as well as obstructive sleep apnea (OSA) and snoring. Primary oral function impairment can result in unwanted physiological responses, including compensation, which is often associated with various problems (e.g., muscle pain). Forward head posture and other muscular skeletal compensations can lead to muscle pain in the head or neck, or both.

U.S. Pat. No. 5,752,822 discloses an apparatus used to move the tongue to treat primary oral function impairment. The apparatus has tongue-positioning extensions that elevate the tongue to relieve restriction of the upper respiratory passage behind the oral cavity. Opening the upper respiratory passage can reduce unwanted impairment of the primary oral functions. U.S. Pat. No. 5,794,627 discloses a dental appliance with elastic bands extending between a top dental tray for upper teeth and a bottom dental tray for lower teeth. The elastic bands pull the bottom dental tray and lower teeth therein forward relative to the top dental tray and upper teeth therein, thus forwardly advancing the user's mandible (lower jaw) with respect to the maxilla. The anterior portions of the top and bottom dental trays are locked together in a closed position to maintain jaw advancement. Unfortunately, the mandible is pulled forward with a relatively constant force causing unwanted discomfort of the jaw muscles, especially when the appliance is worn for long periods of time. Additionally, because anterior portions of the bottom and top dental trays are locked against one another and have no provision for normal muscular action, the appliance does not permit many oral functions, such as maximal tongue protrusion, drinking, and the like.

### BRIEF SUMMARY OF THE INVENTION

In some embodiments, an orthotic dental system comprises a maxillary orthotic configured to be positioned on a set of maxillary teeth, a mandibular orthotic configured to be positioned on a set of mandibular teeth, and an articulator system connecting the maxillary orthotic to the mandibular orthotic. The articulator system comprises a first upper joint and a second upper joint coupled to respective opposing sides of the maxillary orthotic, a first lower joint and a second lower joint coupled to respective opposing sides of the mandibular orthotic, a first rigid arm extending between the first upper joint and the first lower joint such that the first rigid arm pivots with respect to both the maxillary and mandibular orthotics, and a second rigid arm extending between the second upper joint and the second lower joint such that the second rigid arm pivots with respect to both the maxillary and mandibular orthotics.

In some other embodiments, an orthotic dental system comprises an upper dentition orthotic, a lower dentition orthotic, and an articulator system extending between the upper and lower dentition orthotics. The articulator system has at least one rigid connector pivotally coupled to both the upper dentition orthotic and the lower dentition orthotic. A spacer is positioned and configured to maintain the upper dentition orthotic apart from the lower dentition orthotic by at least a desired distance.

In yet other embodiments, an intraoral dental system comprises an upper orthotic configured to receive a user's upper dentition and a lower orthotic configured to receive the user's lower dentition. The lower orthotic is positioned with respect to the upper orthotic so as to create an anterior displacement of a mandible of the user with respect to a neutral position of the user's mandible and to define a window. The window is dimensioned and configured to permit the user's tongue to extend out of the user's mouth while the intraoral dental system is worn.

In some embodiments, a method of positioning a dental orthotic in a mouth of a user is provided. The method comprises positioning an upper orthodontic device on an upper dentition of the user. A lower orthodontic device is positioned on a lower dentition of the user such that a mandible of the user is positioned anterior with respect to a neutral position of the user's mandible to define a minimum gap between the upper and lower orthodontic devices. The gap is dimensioned and configured to permit a tongue of the user to extend out of the user's mouth.

### BRIEF DESCRIPTION OF THE SEVERAL VIEWS OF THE DRAWINGS

FIG. 1A is a side elevational view of an individual wearing an intraoral dental system, according to one illustrated embodiment.

FIG. 1B is a cutaway view of the individual of FIG. 1A, wherein the dental system is positioned in the mouth, according to one illustrated embodiment.

FIG. 1C is a side elevational view of an intraoral dental system positioned on a skull, according to one illustrated embodiment.

FIG. 1D is an enlarged view of a joint of the skull of FIG. 1C, according to one illustrated embodiment.

FIG. 2 is a front elevational view of an intraoral dental system in a user's mouth, according to one illustrated embodiment.

FIG. 3 is a top plan view of a mandibular orthotic, according to one illustrated embodiment.

FIG. 4 is a perspective view of a mandibular orthotic positioned on a set of lower teeth, according to one illustrated embodiment.

FIG. 5 is a side elevational view of an intraoral dental system in an open position.

FIG. 6 is a side elevational view of an intraoral dental system in a closed position.

FIG. 7 is an exploded view of an arm assembly of an intraoral dental system, in accordance with one illustrated embodiment.

FIG. 8 is a side elevational view of a connector for an arm assembly, in accordance with one illustrated embodiment.

FIG. 9 is a longitudinal cross-sectional view of the connector of FIG. 8.

FIG. 10 is a side elevational view of a connector for an arm assembly, in accordance with one illustrated embodiment.

FIG. 11 is a side elevational view of an intraoral dental system, in accordance with one illustrated embodiment.

FIG. 12 is a front elevational view of the intraoral dental system of FIG. 11.

FIG. 13 is a side elevational view of a mounting system with a spacer assembly, in accordance with one illustrated embodiment.

FIGS. 14A and 14B are front elevational views of the mounting system of FIG. 13, in accordance with illustrated embodiments.

FIG. 15 is an exploded view of a spacer of a spacer assembly, in accordance with one illustrated embodiment.

FIG. 16 is a front elevational view of a mounting plate of the dental system of FIG. 11.

FIG. 17 is a side elevational view of the mounting plate of FIG. 16.

FIG. 18 is an isometric view of an articulator system positioned on a skull.

FIG. 19 is a side view of an articulator system positioned on a skull.

### DETAILED DESCRIPTION OF THE INVENTION

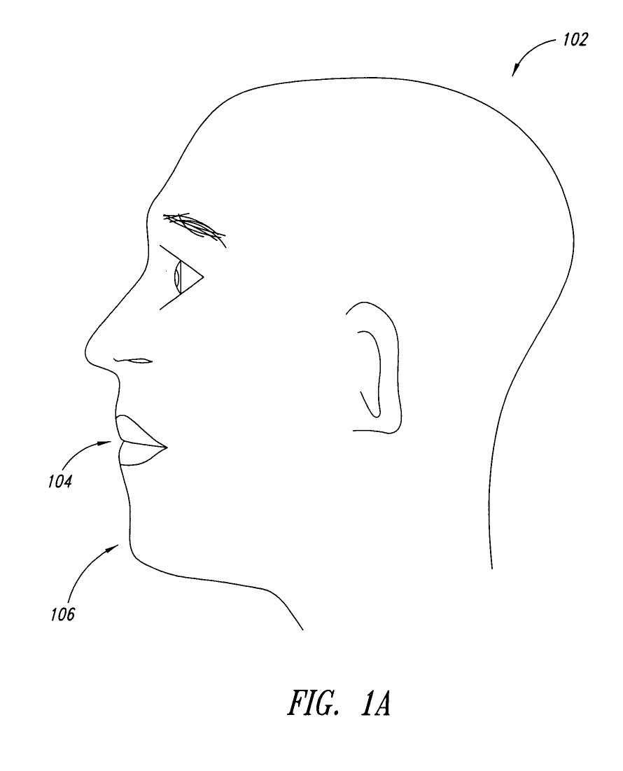

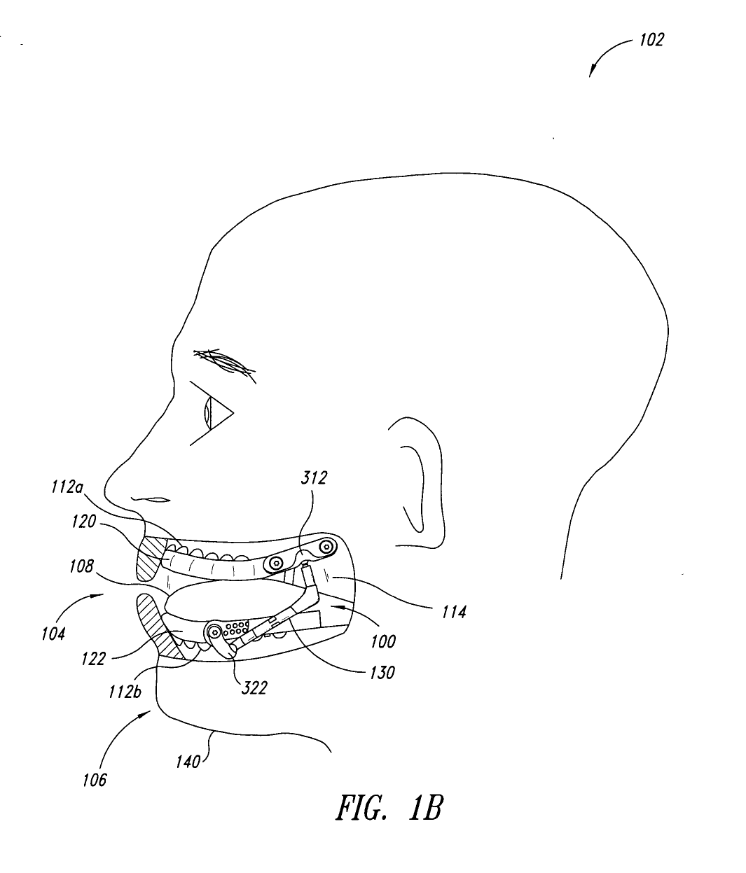

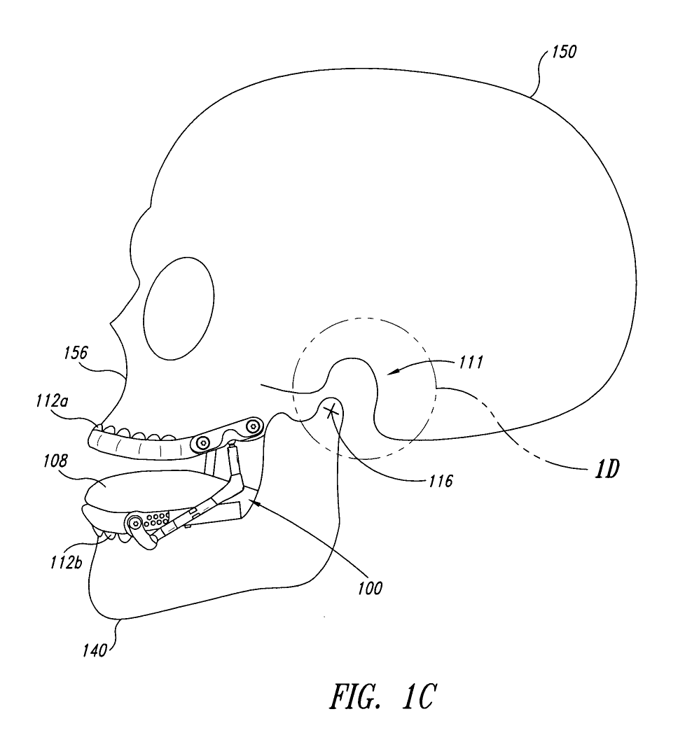

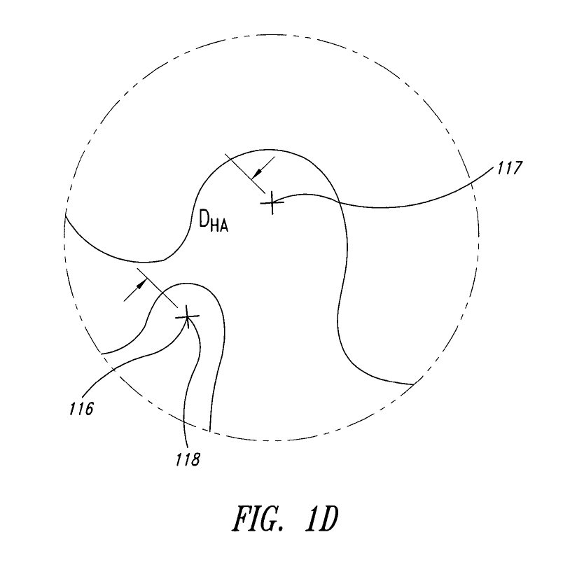

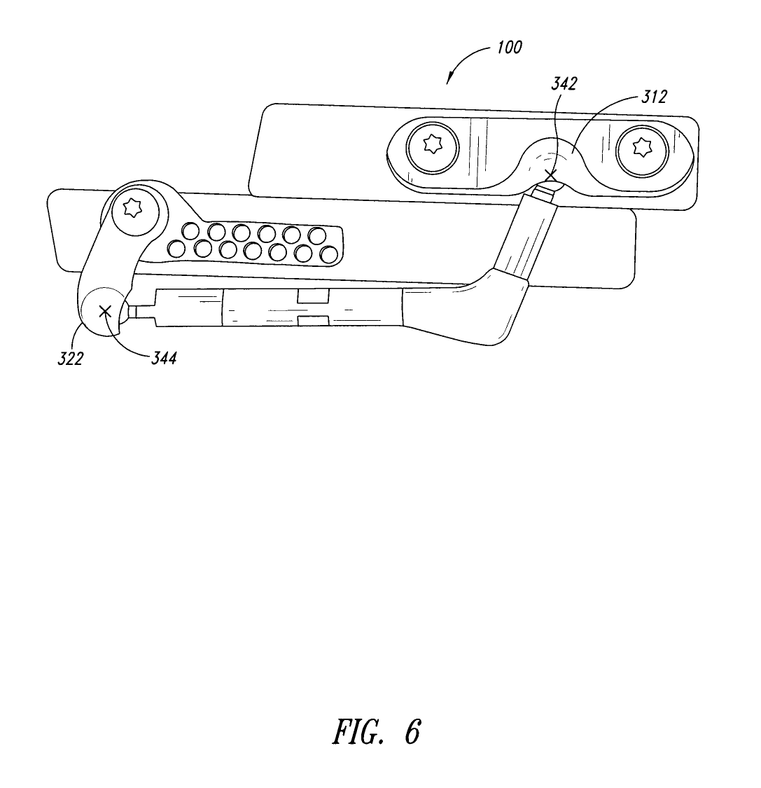

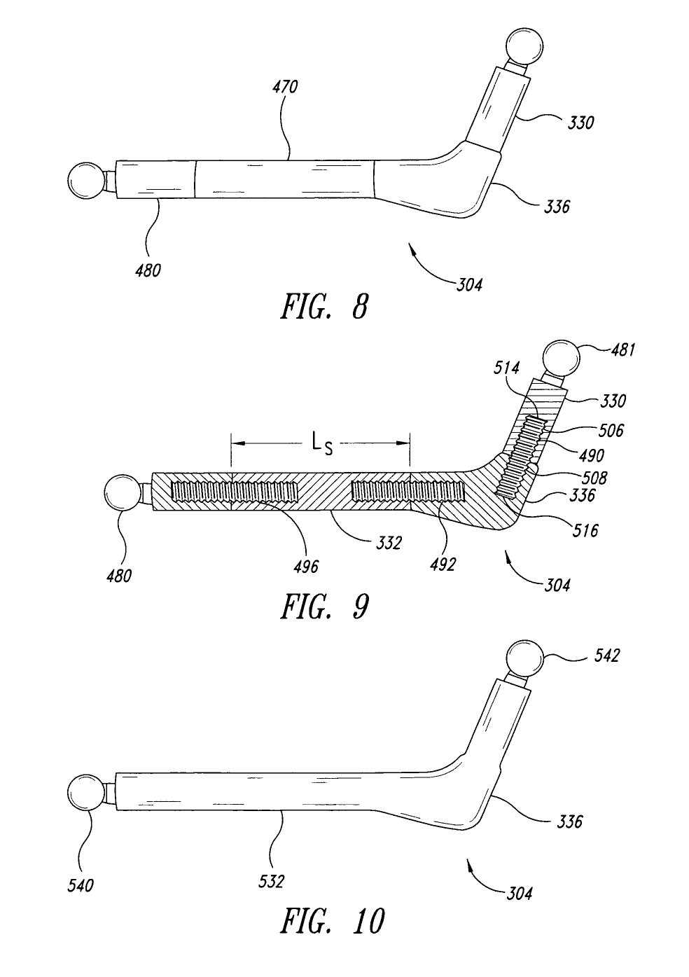

The present detailed description is generally directed to orthotics configured to position one or more anatomical features of a user. Anatomical features can be positioned to elicit a desired response in order to treat various problems, for example problems associated with body compensations. Many specific details and certain example embodiments are set forth in the following description and in FIGS. 1A-19 to provide a thorough understanding of such embodiments. One skilled in the art, however, will understand that the disclosed embodiments may be practiced without one or more components or features described in the following description. Additionally, the orthotics are described in the context of positioning anatomical features of the mouth because they have particular utility in this context. For example, orthotics may be particularly well suited for displacing the mandible with respect to the position of the mandible that allows a more normal tongue position in the mouth and throat, thereby inducing a desired response, such as a physiological response that minimizes, reduces, limits, or substantially eliminates unwanted oral impairment. The orthotics disclosed herein can also be used in other contexts, such as, for example, to position the mouth in order to perform dental procedures (e.g., surgical procedures). In some embodiments, the orthotic can be in the form of a mouth guard, for example a protective or athletic mouth guard. Thus, the orthotics can be used alone or in conjunction with other devices or procedures.

As used in this specification and the appended claims, the singular forms “a,” “an,” and “the” include plural referents unless the content clearly dictates otherwise. Thus, for example, reference to an orthotic that includes “a connector” includes an orthotic with a single connector or an orthotic with two or more connectors, or both. It should also be noted that the term “or” is generally employed in its sense including “and/or” unless the context clearly dictates otherwise.

FIGS. 1A and 1B illustrate a user 102 wearing an intraoral dental system 100 useful for positioning and supporting anatomical features of the mouth 104 to prevent, ameliorate, treat, or otherwise address various types of unwanted symptoms, conditions, diseases, disorders, or combinations thereof. By supporting the mouth 104 and jaw functioning, the dental system 100 can maintain or restore proper oral functioning. The user's jaw 106, for example, can be positioned to provide a desired range of motion of the tongue 108 to manage pain, such as muscle pain in the head, neck, shoulder, facial pain (e.g., TM joint related pain), and the like.

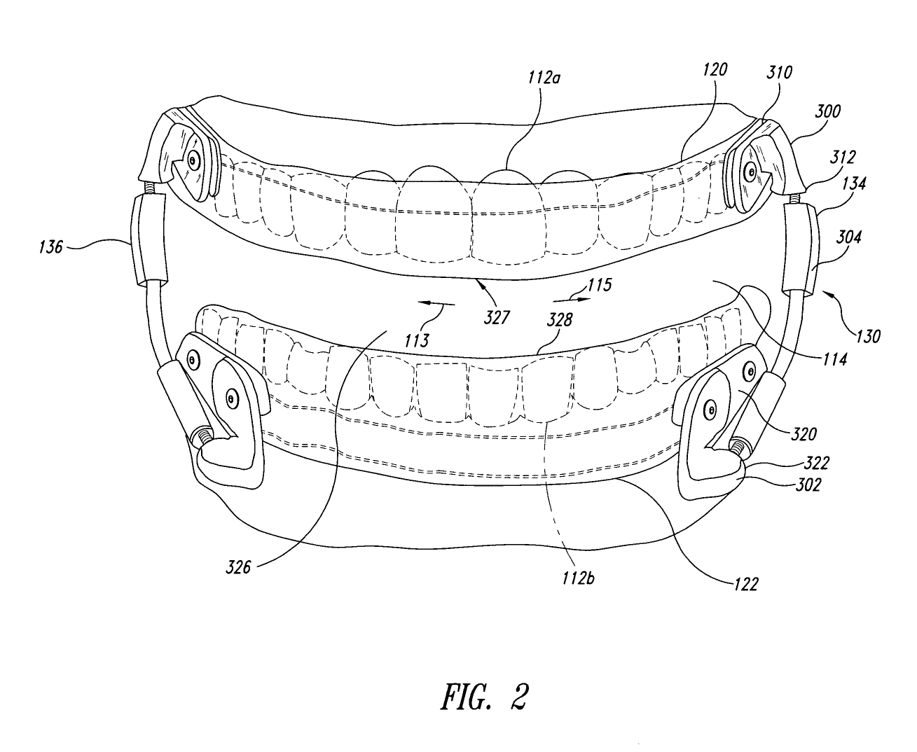

The user's mandible 140 of FIGS. 1B and 1C can travel along a path of opening or closing that maintains an open throat. The temporal mandibular joint (TMJ) 111 defines a hinge axis 116, and connects the mandible 140 to the skull 150 to maintain proper engagement of the condyle-disk assemblies and glenoid fossae. The TM joint 111 and the intraoral dental system 100 cooperate to reposition the mandible 140 with respect to the maxilla 156. The dental system 100, in some embodiments, allows for a desired amount of lateral movement (e.g., border movements indicated by the arrows 113, 115 of FIG. 2), excursion (e.g., protrusive excursion, retrusive excursion, or both), and opening or closing of the jaw 106, while the dental system 100 remains fitted to the user 102.

Mandibular dysfunction can be an impairment of the primary oral functions, including, but not limited to, swallowing, speaking, and breathing. For example, one aspect of mandibular dysfunction is an increased difficulty in swallowing, which may pose significant problems with eating solid foods or swallowing liquids.

Displacing the mandible 140 can also improve oral functions by relieving the body from its compensatory neuromuscular responses and the resultant autonomic nervous system dysfunctions. When the autonomic nervous system no longer needs to react to unnatural musculoskeletal and other physiological compensatory responses caused by incorrect tongue shape or positioning, it can dedicate more of its finite energy to fighting other symptoms, conditions, or diseases, or correcting other indications.

The intraoral dental system 100 of FIGS. 1B and 1C can elicit one or more responses attributable to the tongue 108 engaging anatomical features, such as the upper teeth 112a and/or lower teeth 112b (collectively 112), as well as other various tissues in the mouth. Contact between the tongue 108 and the teeth 112 can cause muscle contractions, which affect the shape and position of the tongue 108, which in turn may affect the pharynx by, for example, reducing the compressive forces on the pharynx. When the oral cavity 114 (see FIG. 1B) is too small, movement of the tongue 108 can be substantially restricted resulting in the tongue obstructing the pharynx, thus impairing many types of oral functions. Tongue protrusion can open the pharynx and can significantly alter the configurations (e.g., the size, shape, etc.) of the velopharynx, oropharynx, and/or hypopharynx for improved breathing. For example, tongue protrusion can increase the cross-sectional areas of breathing passageways for improved ease of breathing. Even when wearing the dental system 100, the user 102 has enough jaw movement to perform typical activities, such as drinking, talking, sleeping, and the like.

The illustrated dental system 100 can advance and lower the jaw 106 in desired directions to increase the size of the oral cavity 114. The tongue 108 held in the mouth 104 may be in an aberrant position causing problems when performing oral functions. For example, the tongue 108 can interfere when swallowing, speaking, or breathing resulting in mandibular dysfunction and initiation of compensations to maintain the oral and mandibular functions.

The dental system 100 can translate (e.g., forwardly) the hinge axis 116 of the jaw 106 a distance DHA (FIG. 1D) from the neutral centric position 117 to an adjusted position 118. In some non-limiting embodiments, the distance DHA can be at least 1 mm, 2 mm, 3 mm, 5 mm, 8 mm, 10 mm, or 12 mm, or ranges encompassing such distances. In some non-limiting embodiments, the distance DHA can be at least 12 mm, 13 mm, or 14 mm. Other distances are also possible. In some embodiments, the dental system 100 can provide at least about 95%, 90%, 80%, 70%, 65%, 60%, 50%, or 40% of the maximum mandibular protrusion, or ranges encompassing such percentages. In some embodiments, the dental system 100 can protrude the jaw 106 about 100% of the maximum mandibular protrusion. The amount of mandibular protrusion can be selected based on the need of the user, and thus, other amounts of protrusion positions are also possible. For example, the dental system 100 can be used to provide maximal protrusion, maximal retrusion, increased or decreased border movements, or positioning in intermediate positions of the tongue or mandible, or both.

With reference again to FIG. 1B, the dental system 100 includes a maxillary orthotic 120, a mandibular orthotic 122, and an articulator system 130 extending between and attached to the maxillary and mandibular orthotics 120, 122. The maxillary orthotic 120 and mandibular orthotic 122 can closely conform to the upper and lower dentitions, respectively. The articulator system 130 is configured to control jaw movements while providing a desired amount of free movement between the maxillary and mandibular orthotics 120, 122. In some embodiments, the mandibular orthotic 122 can swing away from and towards the maxillary orthotic 120 to open and close the dental system 100.

Referring to FIG. 2, the articulator system 130 includes a pair of rigid arm assemblies 134, 136 extending vertically between the maxillary orthotic 120 and the mandibular orthotic 122. The vertically spaced orthotics 120, 122 can be interposed between the arm assemblies 134, 136 such that the arm assemblies 134, 136 are beside the teeth 112 and close to or against the user's cheeks so as to not interfere with normal movement of the tongue 108.

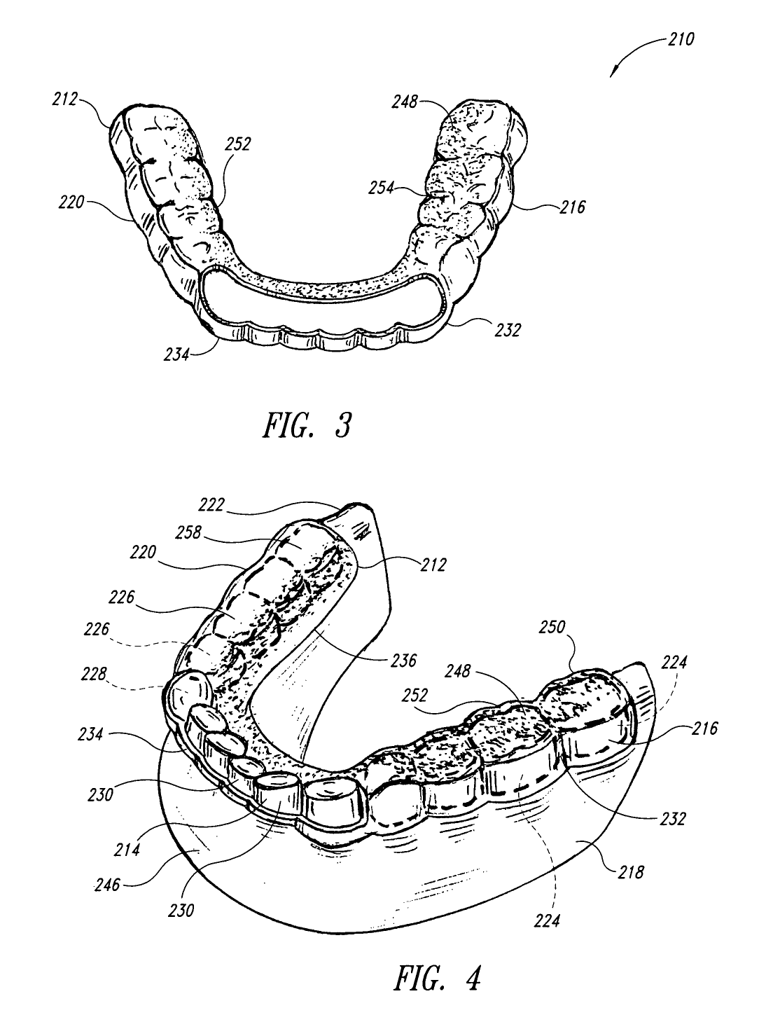

As used herein, the term “orthotic” is a broad term that may include, but is not limited to, a structure configured to be fitted on at least one anatomical feature. The anatomical features can be one or more teeth (e.g., an arrangement of teeth), gums, contours, curved surfaces in the mouth, or combinations thereof. In some embodiments, for example, the orthotics 120, 122 are in the form of mouthpieces, trays, or oral splints configured to engage the dentitions of a user. The orthotics can be configured to support and improve oral functions, as described in connection with FIGS. 3 and 4.

Each of the orthotics 120, 122 is generally U-shaped (as viewed from above) for extending along a set of teeth. The orthotic 120, for example, has an anterior portion for engaging incisors and side posterior portions for engaging posterior teeth, such as the molars. Dentition orthodontic devices are one type of orthotic that can engage the dentition of the user. U.S. Pat. No. 5,752,822 and U.S. Patent Publication No. 2006/0110698 (application Ser. No. 11/246,568) disclose such orthotics that can be incorporated into the dental system 100. These two references are hereby incorporated by reference their entirety. Polymers, plastics, rubbers, metals, and combinations thereof can be used to form the orthotics. For example, each of the orthotics 120, 122 can comprise a flexible and durable material, such as acrylic polymer. One or more reinforcement members (e.g., metal wires) can be incorporated into the orthotic to strengthen the orthotic.

Based on the clinical need, the configurations of the orthotics can be selected to limit, minimize, or substantially prevent relative movement between the orthotic and the teeth. For example, the mandibular orthotic 122 can conform closely to the lower teeth 112b and, accordingly, can be securely coupled to the user's dentition, even when performing a wide range of activities, such as drinking (with or without using a drinking aid such as a straw), talking, sleeping, and the like.

FIGS. 3 and 4 show an orthotic 210 that can be incorporated into the dental system 100. The articulator system 100 supports the jaw 104 and the orthotic 210 alters dental shapes (preferably to allow greater ease of oral functions) to improve oral functions.

The illustrated orthotic 210 comprises a mandibular orthotic 212 which is configured to engage a lower arrangement of teeth, or lower dentition 214, of a user's mouth. The mandibular orthotic 212 includes a first side portion 216 which is positioned on a first side 218 of the lower arrangement of teeth of the user's mouth and a second side portion 220 which is positioned on a second side 222 of the lower arrangement of teeth of the user's mouth. The first side portion 216 and the second side portion 220 may be placed preferably over molars 224, bicuspids 226, cuspids 228 and incisors 230 in the lower arrangement of teeth 214. However, it is understood that the first side portion and the second side portion are designed to conform to at least one tooth on each side of the user's lower arrangement of teeth.

The mandibular orthotic 212 can be made of a somewhat pliable material, such as plastic, which can be molded to the user's teeth when being made and fitted. As shown in FIGS. 3 and 4, a reinforcement 232 preferably made of metal may be added to a front portion 234 and between the first side portion 216 and the second side portion 220 of the mandibular orthotic 212. The illustrated reinforcement 232 is a metal wire that provides strength and adds to the longevity of use of the mandibular orthotic. The front portion may also aid in raising a user's tongue. In other embodiments, the reinforcement 232 can comprise one or more polymers, such as acrylic, fiberglass, carbon fibers, or combinations thereof.

As shown in FIG. 4, the mandibular orthotic 212 may include contours 236 which position the tongue 108 so that the tongue rests on an upper surface of the contours. The contours 236 are provided below the first side portion 216 and/or the second side portion 220 and near a lingual side of the mandibular orthotic 212 such that the contours are lying next to and under the tongue 108. An inner side of each extension has a convex shape at a central region which when positioned beneath the tongue, elevates and advances the tongue forward toward a front 246 of a user's mouth. The contours 236 may be designed to conform to soft tissue on a floor of the user's mouth. The contours 236 are also preferably made of plastic and molded as an addition to the mandibular orthotic 212 described above which is molded to fit selected teeth of the user. It is understood that a depth of the contours 236 may extend further down into the floor of the user's mouth and is dependent upon the size and shape of the user's mouth as long as the user does not experience impinging on tissue or other discomfort. It is also understood that at least one extension is provided and extends from one of the first side portion or the second side portion of the mandibular orthotic. Other types of inwardly extending contours or extensions can also be employed.

The mandibular orthotic 212 includes a plurality of oral contours 248 which may be manipulated and shaped at precise locations during a user's fitting of the mandibular orthotic. The oral contours 248 can address specific physiological symptoms in the user through distinct combinations of jaw alignment and tongue and teeth interaction. The oral contours 248 may include specific shapes such as protrusions 250, depressions 252, and grooves 254 (i.e., conforming to the shapes/sides of teeth). The oral contours 248 are positioned on an inner surface of the first side portion 216 and the second side portion 220 of the mandibular orthotic 212, and may also be positioned on the extensions 236.

The shapes of teeth and tissues in the mouth that contact the tongue may cause muscle contractions in the tongue, thereby affecting the positioning of the tongue, teeth, and tissue in the throat. The contours change the shape of the mandibular orthotic as well as the dental shapes within the mouth, resulting in repositioning of the tongue and tissue of the throat, thereby improving the oral functions as well as relieving neuromuscular responses and autonomic nervous system dysfunctions. The oral contours 248 are made and fitted by selectively adjusting the mandibular orthotic 212 or by adding a material, such as acrylic, to the mandibular orthotic so that it is built up at specific locations. Similarly, in areas where there is excessive enlargement on the mandibular orthotic 212, the size of the contours 248 may be decreased.

There are specific mandibular relationships that, if altered by using the dental system 100, may provide therapeutic benefits and decreased need of body compensations by certain muscles. For example, listed below is the relationship between the region of the user's mouth and areas of the body where muscle contraction causing pain may occur due to impaired oral functions.

First molar=shoulder, temple areas, and other regions;

Second Bicuspid=one-third down the upper half of the back from the shoulder to the mid back and other regions;

First Bicuspid and Cuspid=two-thirds down the upper half of the back from the shoulder to the mid back and other regions; and

Lateral and Central Incisors=the posterior mid back region at the level of the diaphragm and other regions.

Areas of muscle contraction symptoms may be controlled if adjacent muscle groups are well balanced through alteration of the dental orthotic. The following conditions, including enlarging or decreasing the thickness, shape and position of the contour on the dental orthotic are taken into consideration when the dental orthotic is being fitted and made:

(1) When the user's tongue is not free to move up out of the throat and into the mouth, muscle contractions may occur and lead to pain stimulated in specific locations of the head, neck, shoulder and/or upper back. Enlarging a contour may position the tongue to an opposite side of the mouth and allow the tongue to freely move up from the throat into the mouth. The jaw opening and contour size can cooperate to laterally position the tongue.

(2) When the jaw of the user is positioned to one side, the user's tongue may not freely move to the opposite side of the mouth. Muscle contractions may occur and lead to pain stimulated in the head, neck, shoulder and upper back on the same side that the jaw is positioned. If the dental bite of the user contacts on one side, the jaw muscles on the opposite side may have increased muscle contraction too.

(3) When the tongue is prevented from moving over occlusal surfaces (i.e., the grinding surface) of the bicuspid teeth, there may be discomfort in the hip area of the opposite side. Hand pain may also occur under these circumstances.

(4) When the tongue does not freely pass over the first molar on a side of the mouth, there may be discomfort in the most inferior portion of the web of muscle between the thumb and first finger, and in the mid neck area on the opposite side of the body. There may also be hand pain such as thumb muscle tightness.

(5) When the tongue does not rest on the occlusal of the second bicuspid, thumb muscle tightness and/or pain may be present and superior to the region stimulated by the first molar. There may also be discomfort in the upper neck on the opposite side.

(6) When the tongue does not rest on the occlusal and lingual surfaces the first bicuspid and cuspid, there may be thumb muscle tightness and/or pain superior to the region stimulated by the second bicuspid. There may also be discomfort in the neck near the base of the skull on the opposite side.

(7) When the orthotic has excessive thickness in the region inferior to the molars and second bicuspid, discomfort in the anterior thigh and knee area may be present.

(8) When the dental orthotic is enlarged on the second molar and movement of the tongue is restricted, excessive lateral head tilt to the same side and diminished effectiveness of the teeth and structure anterior to the second molar may be present. An enlarged orthotic on the second molar may also result in elevation of the tongue to the soft palate. Nasal and sinus symptoms on the same side, gagginess and a reduction of the normal throat dimension in the hypopharynx may result as well. There may also be nerve like symptoms below the eye on the same side, pressure and pain in the lateral posterior skull on the opposite side and lateral posterior neck pain in the lower half of the neck on the opposite side.

(9) When the tongue is restricted from moving past the most posterior portion of the second molar, there may be same side discomfort in the upper back just below the crest of the shoulder and immediately lateral.

(10) When a contour is enlarged near a mid molar area at the greatest height of the tooth near the occlusal surface of the tooth, reduction of muscle contraction pain at the top of the shoulder and immediately to the same side of the midline results. Temple and sub occipital discomfort also frequently relate to this region and resolves as the tongue is directed more anteriorly. Therefore, it is imperative that movement of the tongue anteriorly is not impaired by the mandibular anterior region.

(11) When contours in the area anterior and inferior to the first molar is excessively thick, muscle tightness in the shoulder on the opposite side and difficulty with elevation of the shoulder may be present.

(12) When contours have excessive thickness in the area below the bicuspids and cuspid, discomfort on the ulnar side of the hand and wrist may be present. The more posterior the oral area, the more superior the ulnar side forearm pain up to the elbow may exist.

(13) When contours have excessive thickness in the region inferior to the molars and second bicuspid near the back teeth, discomfort to the anterior thigh and knee area may be present.

It is understood that contours are molded as an addition to the mandibular orthotics described above which is molded to fit selected teeth of the user. The oral contours may include one contour or a plurality of contour shapes as long as the contours are provided in a manner that allows specific physiological symptoms to be addressed. The relationships between contours and specific muscle groups are not limited to those discussed above. Furthermore, depending on the user's symptoms being treated, the mandibular orthotic may be designed with only contours and no extensions, and vice versa.

The maxillary orthotic (e.g., the maxillary orthotic 120 alone or in combination with a mandibular orthotic) can likewise have contours, extensions, or other features for interacting with the tongue, lower teeth, or the mandibular orthotic. In some embodiments, for example, the maxillary orthotic includes contours that help position the tongue 108 in the oral cavity. Additionally or alternatively, the maxillary orthotic can have contours similar to the contours 248 discussed in connection with FIGS. 3 and 4. The contours of the maxillary orthotic may or may not extend into or near the palate area.

Referring again to FIGS. 1B, 2, and 5, the arm assemblies 134, 136 can be generally similar to each other, and accordingly, the following description of one of the arm assemblies applies equally to the other.

The arm assembly 134 has an upper end 300 and an opposing lower end 302 fixedly coupled to the orthotics 120, 122, respectively. A connector 304 of the arm assembly 134 extends between and is pivotally coupled to the upper and lower ends 300, 302. The upper end 300 includes a mounting system 310 that cooperates with the connector 304 to form a joint 312 that defines an axis of rotation 342 about which the connector 304 rotates. The lower end 302 has a mounting system 320 that cooperates with the connector 304 to form a joint 322 that defines an axis of rotation 344 about which the connector 304 rotates. The joint 312 can be positioned on one side of an occlusal plane (e.g., the mandibular occlusal plane) and the joint 322 can be positioned on the other side of the occlusal plane. The lower end 302 also defines a pivot axis 349 about which the connector 304 pivots. A fastener 351 can pivotally couple the mounting system 320 to the mandibular orthotic 122. When the dental system 100 is articulated, the mounting system 320 and connector 304 can be pivoted about the axis 349.

The illustrated joints 312, 322 are ball and socket joints. The mounting systems 310, 320 define sockets that retain respective opposing balls of the connector 304. The balls can be formed of a wear resistant material (e.g., tool steel, titanium alloy, hardened materials, and the like) for a durable wear resistant joint. Other types of joints having different configurations can also be employed. For example, the joints 312, 322 can be in the form universal joints, knuckle joints, pin joints, or other means for pivotally connecting the connector 304 to the orthotics 120, 122.

The connector 304 can be positioned between the user's cheek and teeth 112 such that the connector 304 does not inhibit normal movement of the tongue 108 when, for example, talking, drinking liquids, and the like. Thus, the dental system 100 can be comfortably worn for extended periods of time. Traditional dental appliances can undesirably limit the range of motion of the user's tongue, for example, between the lower and upper incisors, thereby adversely affecting speech and other normal oral functions. Advantageously, the illustrated dental system 100 allows normal protrusion of the tongue between the upper and lower incisors. FIG. 2, for example, shows a window 326 in the form of a gap defined by a lower surface 327 of the maxillary orthotic 120 and an opposing upper surface 328 of the mandibular orthotic 122. The tongue 108 can extend through the window 326 and protrude outwardly past the incisors. The distance between the orthotics 120, 122 can be increased or decreased to increase or decrease the size of the window 326. At least a portion of the window 326 can be positioned between the upper central incisors and the lower central incisors, although other positions are also possible.

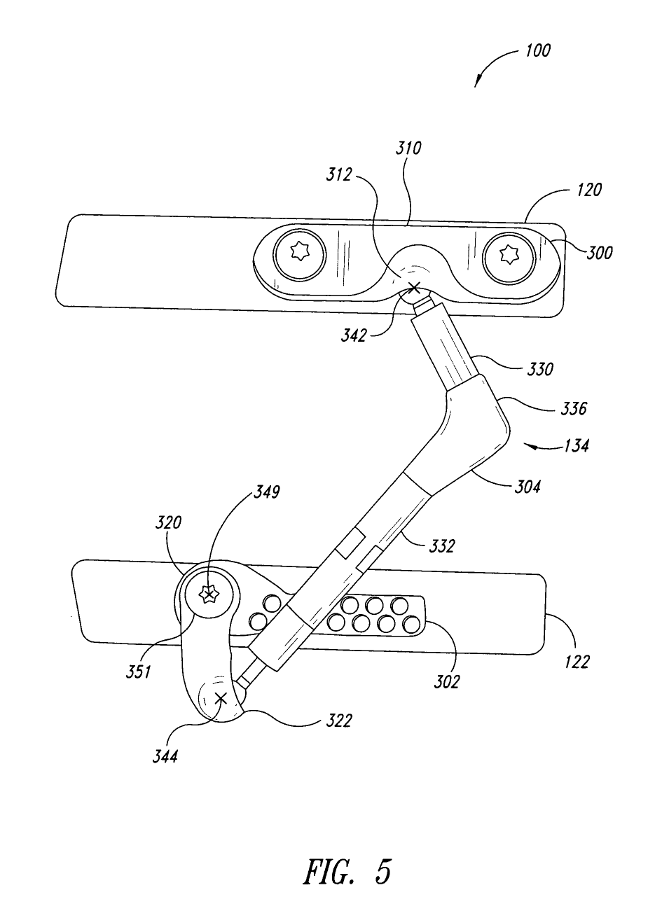

With reference again to FIG. 5, the connector 304 includes a first member 330, a second member or spacer 332, and an elbow 336 therebetween. When the dental system 100 is worn, the first member 330 can extend generally downwardly from the mounting system 310 to the elbow 336, as shown in FIG. 1B. The second member 332 can extend forwardly from the elbow 336 to the mounting system 320.

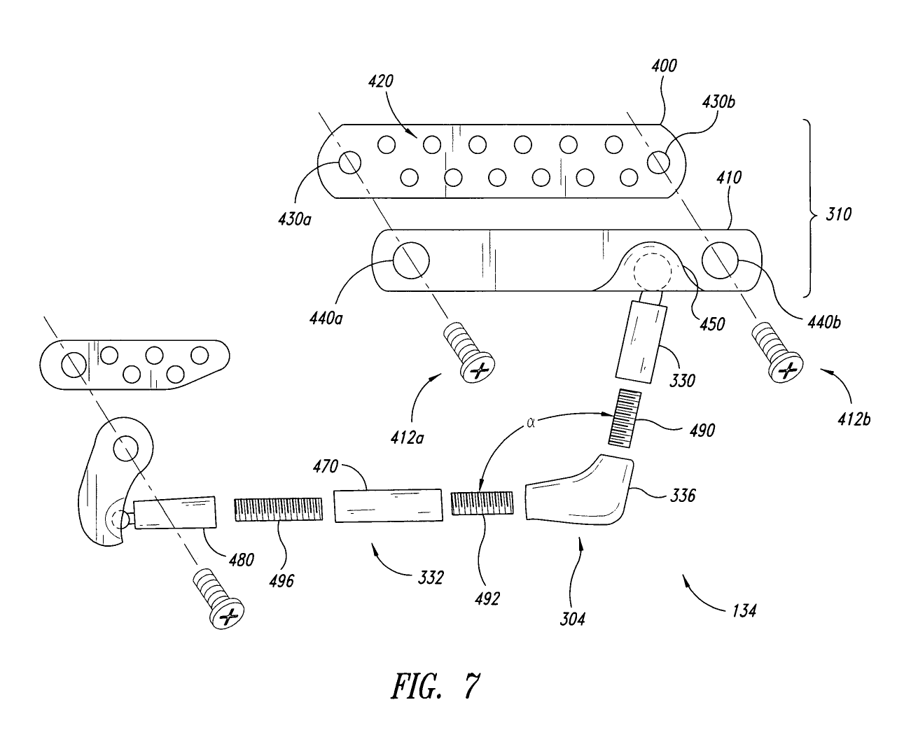

FIG. 7 is an exploded view of the modular arm assembly 134. The mounting system 310 includes a mounting plate 400, a bracket 410, and a plurality of fasteners 412a, 412b (collectively 412) that pass through the bracket 410 and plate 400 and into the maxillary orthotic 120. When assembled, the mounting plate 400 is sandwiched between the bracket 410 and the orthotic 120, and can help distribute loading to the orthotic 120 for improved durability. The term “fastener” as used herein is a broad term that includes, without limitation, a threaded member, screw (illustrated in FIG. 7), rivet, bolt, and other coupling means suitable fixedly coupling two components together.

The illustrated mounting plate 400 of FIG. 7 has a generally flat body, a plurality of apertures 420, and a pair of openings 430a, 430b (collectively 430). The mounting plate 400 can be mounted upon the outer surface of the orthotic 120. In other embodiments, the mounting plate 400 is embedded in the orthotic 120 via, for example, a molding process or embedding process. During a molding process, for example, moldable material (e.g., material, such as acrylic, forming the orthotic 120) can flow through the apertures 420 to effectively lock the mounting plate 400 to the orthotic 120. Alternatively or additionally, bonding agents, adhesives, and other coupling means can couple the mounting plate 400 to the orthotic 120. Thus, various mounting means can be used to permanently or temporarily couple the mounting plate 400 to the orthotic 120.

The bracket 410 includes a pair of openings 440a, 440b (collectively 440) that correspond to the openings 430a, 430b, respectively. The bracket 410 also includes a socket 450 that forms a portion of the joint 312, as noted above. The illustrated downwardly facing socket 450 is interposed between the openings 440a, 440b. The socket 450, however, can also be at other locations, if needed or desired.

To assemble the mounting system 310, the fasteners 412 can be passed through respective openings 440, 430 and into the orthotic 120. Alternatively, the fasteners 412 can be passed through the openings 440 of the bracket 410 and a pair of the apertures 420 of the mounting plate 400.

The installed fasteners 412 can be removed to move the mounting system 310 to a desired position along the orthotic 120. Once the mounting system 310 is repositioned, the fasteners 412 can be used to couple the mounting system 310 to the orthotic 120 once again. During a treatment program, the mounting system 310 can be repositioned any number of times to adjust the position of the jaw 106.

Referring to FIGS. 7 to 9, a plurality of connectors can couple together adjacent sections of the connector 304. As used herein, the term “connector” is broadly construed to include, without limitation, one or more fasteners, externally threaded members, expansion screws, pins, rod, and other connecting means suitable for temporarily or permanently coupling components together. For example, a threaded connector 490 detachably couples the first member 330 to the elbow 336. A threaded connector 492 detachably couples the elbow 336 to a spacer 332. The threaded connector 496 detachably couples the spacer 332 to the joint member 480.

The connectors 490, 492, 496 may be generally similar to one another, and accordingly, the following description of one of the connectors applies equally to the others. In the illustrated embodiment of FIG. 9, a first end 514 of the connector 490 extends through a passageway 506 of the first member 330. A second end 516 of the connector 490 extends through a passageway 508 of the elbow 336. The passageways 506, 508 can have internal threads for threadably engaging external threads connector 490.

The first and second ends 514, 516 can be configured to engage a tool (e.g., a wrench, a polygonal wrench such as a hex wrench, Hex key, Allen wrench, and the like), a screwdriver (e.g., a flat head screwdriver, slotted screwdriver, Philips screwdriver, and the like), and other torquing tools. As such, the connector 490 can be conveniently twisted into and out of a threaded component. Once assembled, the first member 330 and elbow 336 can be rigidly locked together. The elbow 336, spacer 470, and joint member 480 can be connected together in a similar manner. In some embodiments, including the illustrated embodiment, the connectors 490, 492 held by the elbow 336 define a right or an obtuse angle α. The angle α can be at least about 90 degrees, 100 degrees, 110 degree, 120 degrees, 150 degrees, 160 degrees, or ranges encompassing such angles. In other embodiments, the angle α can be equal to or less than about 90 degrees. Other angles are also possible.

Advantageously, the modular connector 304 can be disassembled in order to adjust its dimensions. For example, the spacer 470 can be replaced with another spacer having a different longitudinal length Lₛ to change the distance between the centers of the balls of the joint members 480, 481. Other components of the connector 304 can likewise be replaced with components having other dimensions.

The connector 304 can be formed, in whole or in part, of metal (e.g., steel, aluminum, titanium, combinations thereof, and the like), composites (e.g., fiber reinforced composites), polymers, plastics, and the like. One of ordinary skill in the art can determine the appropriate combination of material type, thickness, and shape to achieve the desired physical properties, such as stiffness, based on the applied loads, such as when the user bites down.

In some embodiments, including the illustrated embodiment of FIG. 10, the connector 304 has a one-piece construction. A main body 532 of the connector 304 extends between the joint members 540, 542. A rigid member or bar can be bent to form the main body 532. In other embodiments, a molding process (e.g., an injection molding process, compression molding process, and the like), extrusion process, or thermoforming process can be used to form the main body 532.

In operation, the dental system 100 can be placed in the user's open mouth 104. The maxillary orthotic 120 can be fitted to the upper teeth 112a and the mandibular orthotic 122 can be fitted to the lower teeth 112b. Because the orthotics 120, 122 snugly hold the teeth 112, they substantially limit unwanted movement of the dental system 100 with respect to the dentition.

The upper joint 312 is generally adjacent to the posterior teeth that are suitable for bearing relatively large forces. In the illustrated embodiment of FIG. 1B, the joint 312 is laterally spaced from and slightly below the first and second maxillary molars. The lower joint 322 can be positioned anterior to one or more of the lower molars. The lower joint 322, for example, can be positioned anterior of the nearest lower molar. In some embodiments, the lower joint 322 can be generally adjacent to the mandibular canines or bicuspid region. Other locations of the joints 312, 322 are also possible.

The dental system 100 may or may not be worn discreetly. For example, even though the dental system 100 keeps the jaw 106 from completely closing, the user's lips can typically be closed such that the dental system 100 is not readily noticeable. The dental system 100 can be comfortably and discreetly worn for any desired length of time.

The dental system 100 holds the mandible 140 in a lowered forward position while allowing a desired amount of jaw movement to treat mandibular dysfunctions for improved oral functions, including, without limitation, swallowing, speaking, breathing, and the like, as well as other symptoms, conditions, diseases, and disorders associated with mandibular dysfunction. The articulator system 130, maxillary orthotic 120, and mandibular orthotic 122 cooperate to support and position the jaw 104, thus improving jaw functions.

The user 102 can remove the dental system 100 in order to eat or to perform other activities that require complete closing of the mouth 106. If needed or desired, the dental system 100 can also be removed from the mouth 106 to perform various adjustments. If the user finds the dental system 100 uncomfortable, the configuration of the arm assemblies 134, 136 can be adjusted to achieve a desired fit. Any number of adjustments can be performed throughout a treatment program based on clinical needs to obtain the desired level of comfort and efficacy.

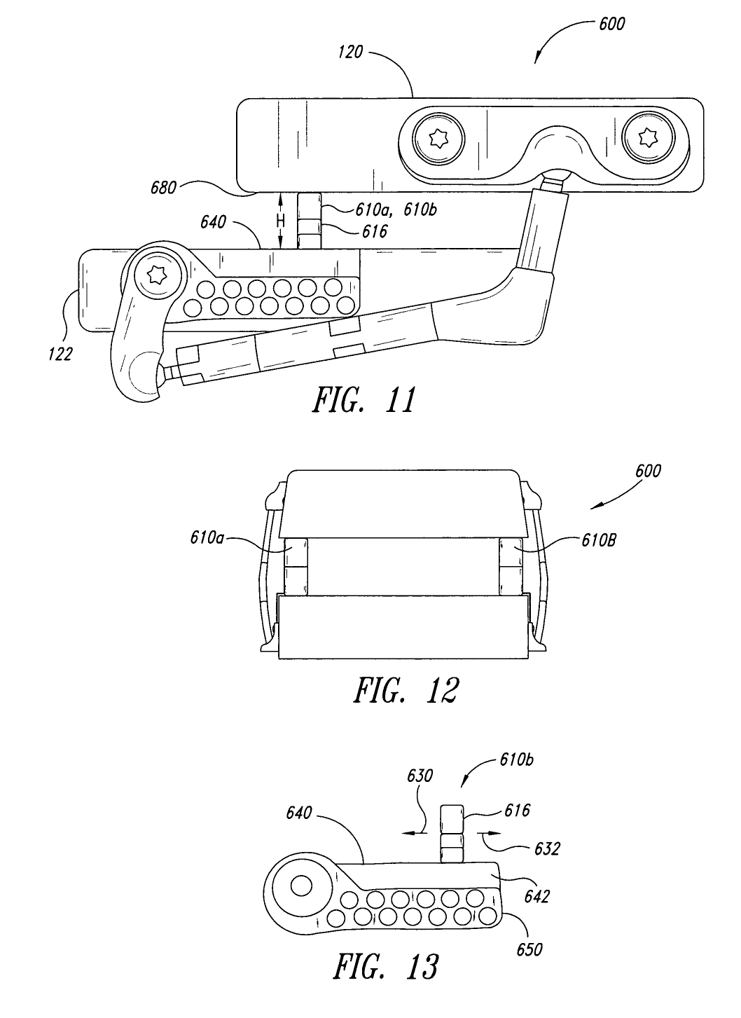

FIGS. 11 and 12 illustrate a dental system 600 including a pair of spacer assemblies 610a, 610b for spacing the maxillary orthotic 120 from the mandibular orthotic 122. The heights H of the spacer assemblies 610a, 610b can be increased or decreased to increase or decrease the distance separating the orthotics 120, 122. In some embodiments, the height H can be at least about 1 mm, 2 mm, 3 mm, 5 mm, 7 mm, 1 cm, 1.5 cm or ranges encompassing such heights. In some embodiments, the height H is at least about 3 mm to provide a comfortable jaw position. Other heights are also possible. When the user's mouth closes, the spacer assemblies 610a, 610b serve as stops. The spacer assemblies 610a, 610b ensure that a minimum separation distance between the orthotics 120, 122 is properly maintained and can thus maintain a desired jaw position so long as the user closes down on the dental system 600. The dental system 600 can be articulated from the illustrated closed position to an open position, similar to the dental system 100 described above.

The dental system 600 is especially well suited for treating users suffering from bruxism (including sleep bruxism, clenching, grinding, and the like), as well as other conditions associated with unwanted occlusal contact as well as symptoms and conditions associated with impaired oral functions. The dental system 600 can position the jaw to alleviate many unwanted problems associated with these disorders, including, for example, systemic symptoms, abnormal wear of teeth, soreness of jaw muscles, noise produced during grinding, headaches, or combinations thereof.

With continued reference to FIG. 12, the spacer assemblies 610a, 610b can be positioned at the opposing lateral sides of the dental system 600, thus ensuring alignment of the mouth when the dental system 600 is closed. A greater or lesser number of spacer assemblies than illustrated can be used to achieve the desired positioning between the orthotics 120, 122.

The spacer assembly 610b of FIGS. 12 and 13 includes a rail 640 and a movable vertical spacer 616. The illustrated spacer 616 can be moved forwardly or rearwardly (indicated by the arrows 630, 632) with respect to the rail 640 between a plurality of preset positions.

The rail 640 extends longitudinally along an upper section 642 of a mounting plate 650. The rail 640 can be temporarily or permanently coupled to the upper section 642. In some embodiments, for example, the rail 640 can be permanently coupled to the upper section 642 with adhesives, welding, bonding, and the like. In some embodiments, the rail 640 can be temporarily coupled to the upper section 642 with removable fasteners.

Referring to FIG. 15, the spacer 616 includes a base or holder 652 and an upper member 654 detachably coupled to the base 652. The upper member 654 has a contact surface 670, a coupling feature 672, and a main body 674 extending between the contact surface 670 and the coupling feature 672. The contact surface 670 is configured to contact a lower surface 680 of the maxillary orthotic 120, as shown in FIG. 11. The upper member 654 can serve as a stop wherein the contact surface 670 can contact the maxillary orthotic 120. The maxillary orthotic 120 can have an alignment or keying feature to facilitate proper alignment of the orthotics 120, 122. In some embodiments, the maxillary orthotic 120 includes a fossa (e.g., an acrylic fossa formed in the orthotic 120) for receiving at least a portion of the upper member 654.

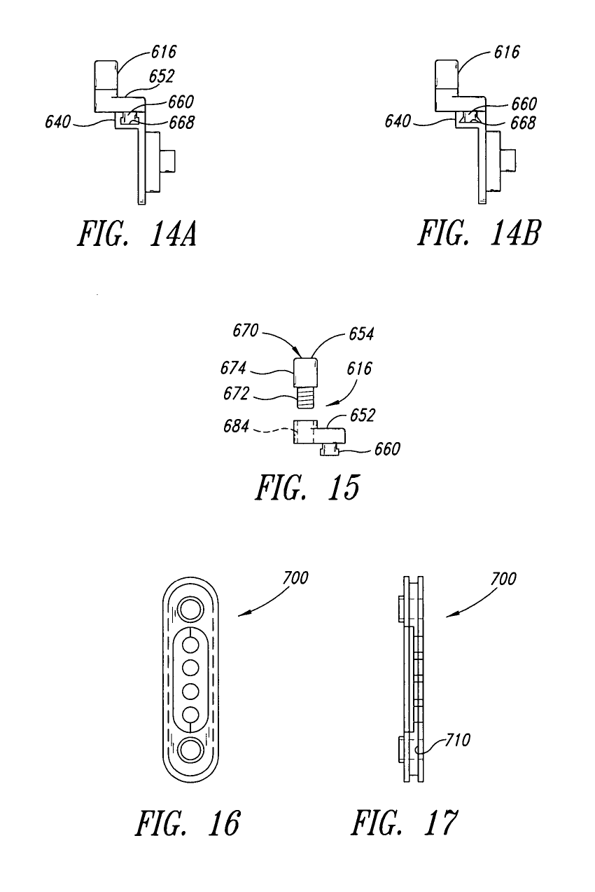

The base 652 of FIGS. 14A and 15 has a slide member 660 that fits within the rail 640. The axial shape of the slide member 660 can be similar to the shape of a channel 668 of the rail 640. The complementary slide member 660 and channel 668 can have various shapes and configurations to permit the desired movement of the spacer 616.

The base 652 also includes a passageway 684 (shown in phantom) for receiving the coupling feature 672. In the illustrated embodiment, the coupling feature 672 is externally threaded and integrally formed with the main body 674. The external threads of the coupling feature 672 can threadably mate with internal threads of the passageway 684 to retain the upper member 654 to the base 652. In some embodiments, the coupling feature 672 is an externally threaded connector that can be received in a threaded passageway 684 and a threaded passageway extending at least partially through the main body 674.

The upper member 654 can advantageously have a longitudinal length selected to achieve the desired separation distance of the orthotics 120, 122. The upper member 654 can be conveniently replaced with an upper member having different dimensions to quickly and conveniently change the separation distance.

The spacer 616 can also have a one-piece construction. For example, the base 652 and the upper member 654 can be monolithically formed for a durable, long-lasting spacer 616. The spacer 616 with either the multi-piece or one-piece construction can be removed from the bracket assembly 642 to allow a greater range of jaw motion.

Additionally or alternatively, one or more spacer assemblies can be coupled to the maxillary orthotic 120 or other component of the dental systems described herein.

FIGS. 16 and 17 illustrate a mounting plate 700 of the dental system 600 of FIG. 11 having a groove or channel 710 extending along its periphery. Material forming the maxillary orthotic 120 can extend into the groove 710 to further limit movement of the mounting plate 700 relative to the maxillary orthotic 120.

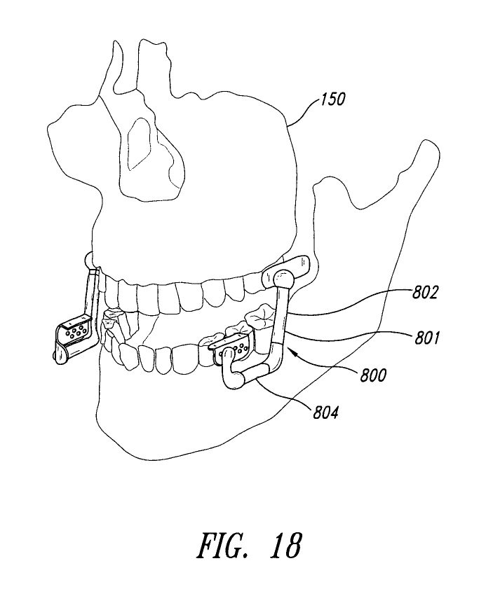

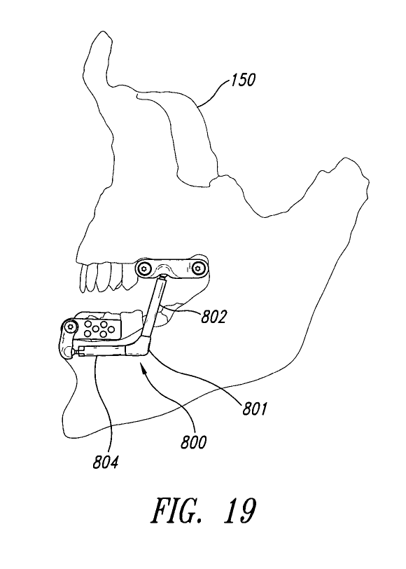

Advantageously, the dental systems described herein can be conveniently modified to adjust the position of the mouth 104. FIGS. 18 and 19 show a dental system 800 (with the orthotics removed) including an articulator system 801 having a first member 802 with a longitudinal length greater than a longitudinal length of the second member 804.

A diagnostic system for assessing upper airway disorders and physiological symptoms may be utilized in designing and fitting the dental orthotic system 100. The diagnostic system aids in the process of custom fitting the user's dentition and optimizes the effectiveness of the orthotic system for each user.

Evaluation of the user is performed by taking a highly specialized history of the user and the symptoms the user is experiencing at an initial office visit. Some user's experience obvious impairments of jaw functions evidenced by their speech, swallowing, eating and breathing characteristics. However, in other individuals these functions above appear normal despite experiencing significant muscle and joint dysfunctions. Therefore, the history is designed to reveal deficits in oral functions, especially apparently minor impairments in the jaw's contribution to breathing, swallowing and speaking.

Imagining (e.g., Radiographs, Video Fluoroscope and Magnetic Resonance Imaging (MRI)) may be used to provide valuable information about the oral function of a user before fitting and treatment with the dental orthotic system. For example, an imaging may reveal that a user's tongue blocks the throat and an epiglottis is obscured by a hyoid bone.

To assist in the evaluation of the dental orthotic system 100 and determining if symptoms are relieved, material (e.g., plastic, temporary wax, and the like) is affixed to the dental orthotics (e.g., the mandibular orthotic or maxillary orthotic, or both). The affixed material and dental orthotics are then covered with pressure indicating paste and the user is encouraged to perform oral functions such as speaking, eating, swallowing, and breathing. After performance of the oral functions are completed, the dental orthotic is removed and the pressure indicating paste is assessed for areas that require modification. The adjustments are made to the dental orthotic system and the performance of oral functions are repeated until appropriate positioning of the jaw 106.

Imaging may again be used to view the user's oral function after treatment using the dental orthotic to determine whether the symptoms have been alleviated. The preferred resulting view is that any contact with the tongue is passive. Once the final adjustments have been made to the dental orthotic and the fitting of the user is completed, the temporary wax on the dental orthotic may be replaced by plastic.

The dental orthotic of the present invention is an effective treatment for upper airway disorders and specific neuromuscular responses and autonomic nervous system symptoms. These symptoms may include muscular pain of the head, face, neck, back, shoulder, hip, knee, elbow, hand and any muscular component associated with the forward head posture related to impaired oral functions, for example, many of the full body effects that have been associated with Temporomandibular Joint (TMJ) concerns. Forward head posture can help open the throat in order to support oral functions and relieve mandibular dysfunctions.

The autonomic nervous system helps maintain body posture and mediates oral functions. Autonomic nervous system symptoms such as elevated heart rate, fatigue, on edge or stress like feelings, cold or warm hands and feet, aversion to cold temperatures, digestive symptoms, visual changes, survival feelings (e.g., fight or flight effects, which may be mistaken for psychological conditions), disturbed sleep, sinus and nasal dysfunctions as well as many other symptoms may be associated with upper airway disorders. These symptoms of the autonomic nervous system dysfunctions may reflect unwanted impairment of the oral functions. A symptom overload of the autonomic nervous system may be the result of an impairment of oral functions.

The dental orthotic moves the tongue and jaw forward which results in the muscles in the rest of body relaxing, thus relieving symptoms and other discomforts. The dental orthotic also corrects the posture of the user. The dental orthotic has high patient acceptance, increased comfort and treatment success for a long period of time.

Other types of compensation are often associated with restricted breathing. In order to force air through the throat, the chest muscles can be elevated and contracted and intra-thoratic pressures can be increased for proper ariflow. Many physiological parameters (e.g., changes in blood pressure, heart rate, blood oxygen saturation, and the like) may be related to reduction and elimination many mechanical effects often needed for proper airflow through the throat.

The dental systems described herein can also ease breathing during sleeping. Sleep disorder breathing may involve the prolapse of the tongue backward into the throat and, thus, may block the throat thereby contributing to impairment of oral functions. Moving the tongue forwardly with the dental system can help open the throat ease breathing.

Various methods and techniques described above provide a number of ways to carry out the invention. A wide array of dental devices (e.g., dental articulators, casts, and the like) can be used to fabricate the dental systems disclosed herein. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. For example, orthotics can be mixed and matched to obtain a desired fit. The various features and acts discussed above, as well as other known equivalents for each such feature or act, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Treatment programs may be tailored based on a wide range of criteria, such as desired length of treatment, comfort, aesthetic appearance, pain states, physiologic measurements, body posture, quality of sleep, neuralgic symptoms, and the like. Other sequences of events or acts, or less than all of the events, or simultaneous occurrence of the events, may be utilized in practicing the disclosed embodiments.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application Nos. 60/617,472; 60/756,683; 60/838,004; U.S. Pat. Nos. 5,752,822; 5,794,627; and U.S. Patent Publication No. 2006/0110698 are incorporated herein by reference, in their entirety. Except as described herein, the embodiments, features, systems, devices, materials, methods and techniques described herein may, in some embodiments, be similar to any one or more of the embodiments, features, systems, devices, materials, methods and techniques described in the incorporated references. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned incorporated references.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, it is not intended that the invention be limited, except as by the appended claims.

What is claimed is:

1. An orthotic dental system comprising:
a maxillary orthotic configured to be positioned on a set of maxillary teeth;
a mandibular orthotic configured to be positioned on a set of mandibular teeth; and
an articulator system connecting the maxillary orthotic to the mandibular orthotic, the articulator system comprising:
a first upper joint and a second upper joint coupled to respective opposing sides of the maxillary orthotic;
a first lower joint and a second lower joint coupled to respective opposing sides of the mandibular orthotic;
a first rigid arm extending between the first upper joint and the first lower joint such that the first rigid arm pivots with respect to both the maxillary and mandibular orthotics; and
a second rigid arm extending between the second upper joint and the second lower joint such that the second rigid arm pivots with respect to both the maxillary and mandibular orthotics.

2. The orthotic dental system of claim 1 wherein, when the orthotic dental system is positioned on a user, the first and second upper joints are positioned on one side of an occlusal plane and the first and second lower joints are positioned on the other side of the occlusal plane.

3. The orthotic dental system of claim 1 wherein the articulator system positions the maxillary orthotic with respect to the mandibular orthotic so as to create an anterior displacement of a user's mandible with respect to a neutral position of the user's mandible.

4. The orthotic dental system of claim 1 wherein the first and second upper joints are ball and socket joints.

5. The orthotic dental system of claim 1 wherein the first and second lower joints are ball and socket joints.

6. The orthotic dental system of claim 1 wherein, when the orthotic dental system is positioned on a user, the first and second upper joints are each adjacent to upper molars of the user.

7. The orthotic dental system of claim 1 wherein, when the orthotic dental system is positioned on a user, the first and second lower joints are each positioned anterior to lower molars of the user.

8. The orthotic dental system of claim 1 wherein the first upper joint and the first lower joint define a set distance, and wherein the first arm is operable to adjust the set distance.

9. The orthotic dental system of claim 1 wherein at least one of the first arm and the second arm comprises a first elongated member and a second elongated member angled with respect to the first elongated member.

10. An orthotic dental system comprising:
an upper dentition orthotic;
a lower dentition orthotic;
an articulator system extending between the upper and lower dentition orthotics, the articulator system having at least one rigid connector pivotally coupled to both the upper dentition orthotic and the lower dentition orthotic; and
a spacer positioned and configured to maintain the upper dentition orthotic apart from the lower dentition orthotic by at least a desired distance.

11. The orthotic dental system of claim 10 wherein the spacer is configured to be positioned in a plurality of preset positions with respect to at least one of the upper dentition orthotic and the lower dentition orthotic.

12. The orthotic dental system of claim 10 wherein the desired distance is 3 mm.

13. The orthotic dental system of claim 10 wherein the spacer comprises a base and a spacer body coupled to the base, the base being coupled to one of the upper dentition orthotic and the lower dentition orthotic such that the spacer body extends towards the other one of the upper dentition orthotic and the lower dentition orthotic.

14. An intraoral dental system comprising:
an upper orthotic configured to receive a user's upper dentition; and
a lower orthotic configured to receive the user's lower dentition, the lower orthotic positioned with respect to the upper orthotic so as to create an anterior displacement of a mandible of the user with respect to a neutral position of the user's mandible and to define a window, the window dimensioned and configured to permit the user's tongue to extend out of the user's mouth while the intraoral dental system is worn.

15. The intraoral dental system of claim 14 wherein the anterior displacement of the user's mandible is sufficient to elicit at least one effective physiological response that comprises a substantial reduction in pain in the head, neck, shoulder, or upper back of the user.

16. The intraoral dental system of claim 14 wherein the window is positioned between upper central incisors and lower central incisors of the user.

17. The intraoral dental system of claim 14 wherein the lower orthotic is selectively movable with respect to the upper orthotic to adjust the anterior displacement of the user's mandible.

18. The intraoral dental system of claim 14, further comprising;
at least one rigid connector pivotally coupled to the upper orthotic and the lower orthotic.

19. A method of adjusting the intraoral dental system of claim 14, the method comprising:
changing at least one dimension of a connector that pivotally couples the upper orthotic to the lower orthotic, after the upper orthotic and the lower orthotic are removed from respective upper and lower dentitions of the user.

20. A method of positioning a dental orthotic in a mouth of a user, the method comprising:
positioning an upper orthodontic device on an upper dentition of the user;
positioning a lower orthodontic device on a lower dentition of the user such that a mandible of the user is positioned anterior with respect to a neutral position of the user's mandible to define a minimum gap between the upper and lower orthodontic devices, the gap dimensioned and configured to permit a tongue of the user to extend out of the user's mouth.

21. The method of claim 20, further comprising:
spacing the upper orthodontic device from the lower orthodontic device to form the minimum gap.
